(19) United States
(12) Patent Application Publication
(10) Pub. No.: US 2008/0304947 A1
(43) Pub. Date: Dec. 11, 2008

(54) Cleanout system for a reciprocating slat conveyor

(76) Inventors: Kenneth A. Stout, Madras, OR (US); Timothy Bryan Cooley, Prineville, OR (US); Daniel W. Jackson, Redmond, OR (US); Travis W. Power, Fremont, CA (US)

Correspondence Address: BARNARD INTELLECTUAL PROPERTY LAW, INC., P.O. BOX 58888, SEATTLE, WA, 98138-1888, US

(21) Appl. No.: 11/811,710

(22) Filed: Jun. 11, 2007

(51) Int. Cl. B60P 1/00

(52) U.S. Cl. 414/525.1; 414/527

(57) ABSTRACT

A sheet member (30) is positioned on the slats (18) of a reciprocating slat conveyor in a container (10). A strap (32) leads from the forward end of the sheet member (30) to and through a guide eye (38) that is mounted at an elevated position (26) adjacent the front wall (16) of the container (10). The strap extends downwardly from the guide eye (38) to a winding reel (36) driven by a motor (34). A block (40) is connected to the strap (32) in a position so that when the front end of the sheet member (30) has been moved by the strap (32) into an elevated position adjacent the front wall (16), the block (40) on the strap (32) will move through the throat (124, 108) of the guide eye (38) to the opposite side of a latch spring (42) that defines one side of the throat (124, 108). When in this position, the block (40) contacts the latch spring (42) and is hard against a reverse movement of the strap (32) and block (40) through the guide eye (38). However, when the conveyor is operated to move material (M) out from the container (10), it will impose a sufficient amount of force on the sheet member (30) to cause a pulling force on the strap (32) sufficient to move the block (40) back through the throat (124, 108) of the guide eye (38), against the force of the latch spring (42).

### TECHNICAL FIELD

This invention relates to reciprocating slat conveyors. More particularly, it relates to the provision of an improved cleanout system for a reciprocating slat conveyor that is used for unloading particulate materials. This invention is an improvement on the cleanout system disclosed and claimed in U.S. Pat. No. 6,974,296, granted Dec. 13, 2005, to Kirk A. Simrin, and entitled Cleanout Cover System For Unloading Particulate Material From Reciprocating Floor Assemblies.

### BACKGROUND OF THE INVENTION

The Background of the Invention set forth in U.S. Pat. No. 6,974,296, the patent itself, and Japanese Patent Pub. Disclosure No. 10-291622, published Nov. 4, 1998, based on Japanese Application No. 9-99255, filed Apr. 16, 1997, and entitled Floor Surface Transfer Method And Floor Surface Transfer System, together provide a Background of the Invention for the subject invention.

U.S. Pat. No. 6,974,296 discloses a strap leading from the front end of a sheet member to a winding reel on which the strap is wound for the purpose of pulling the sheet member forwardly into an elevated position against the front end of the trailer box. A friction brake is provided to hold the strap and prevent rotation of the reel under the influence of the weight of the sheet member when it is desired that the sheet member not move but rather be held in an elevated position at the front end of the trailer. The winding mechanism and friction brake disclosed by the patent, is a complicated mechanism. There is a need to replace this mechanism with a much simpler system that uses a hydraulic motor for turning the winding reel. It is a principal object of the present invention to provide such a simplified system.

### BRIEF SUMMARY OF THE INVENTION

The cleanout system of the invention includes a sheet member having a front end, a rear end and side edges. The sheet member is positioned on a reciprocating slat conveyor that is in a container having sidewalls, with the side edges of the sheet member being positioned adjacent the sidewalls of the container. A guide eye is positioned at an upward forward position in the container and a winding reel is spaced from the guide eye. A strap is wound on the winding reel and extends downwardly through the guide eye to a connection with the front end of the sheet member. The guide eye is elevated in the container to such an extent that the strap can be wound on the winding reel for pulling the front end of the sheet member into an elevated position below the guide eye and adjacent the front end wall of the container.

According to the invention, the guide eye includes a strap passageway defined on one side by a strap contacting bearing and on the other side by a latch spring. The strap is positioned to move in the strap passageway between the bearing and the latch spring. According to the invention, a holding member is connected to the strap. The holding member is thicker than the strap passageway when the latch spring is relaxed. When the strap is wound on the winding reel, the holding member is moved against the latch spring. In response to additional movement of the strap, the holding member moves against and depresses the latch spring and this allows the holding member to move through the guide eye. Following such movement, the latch spring moves back into a relaxed position and blocks the holding member from moving backwards to the first side of the latch spring. When the holding member is in this position, the sheet member is in an elevated position closely adjacent the front end wall of the container. According to the invention, the latch spring is constructed and positioned to again be depressed by the holding member in response to a strong enough pull on the strap which occurs when the reciprocating slat conveyor is being operated to move the load and the sheet member rearwardly towards a rear end discharge opening in the container. During such unloading, the force exerted on the strap will pull the holding member against the latch spring, causing the latch spring to be depressed, allowing the holding member to move through the guide eye passed the latch spring.

Other objects, advantages and features of the invention will become apparent from the description of the best mode set forth below, from the drawings, from the claims and from the principles that are embodied in the specific structures that are illustrated and described.

### BRIEF DESCRIPTION OF THE SEVERAL VIEWS OF THE DRAWINGS

Like reference numerals refer to like parts throughout the several views of the drawing, and:

FIG. 1 is a pictorial view of a trailer, taken from above and looking towards the top, one side and the rear end of the trailer, and showing particulate material being moved rearwardly out from the trailer;

FIG. 2 is a pictorial view looking into the rear discharge opening in the trailer, such view showing a sheet member held in an elevated position adjacent the front end wall of the trailer;

FIG. 3 is a view like FIG. 2, but showing the sheet member lowered into a position on the reciprocating slat conveyor;

FIG. 4 is a side elevational view of the trailer, showing the sheet member in the position shown by FIG. 2 and showing particulate material in the trailer;

FIG. 5 is a view like FIG. 4, but showing the load partially moved out from the trailer and showing the sheet member moving rearwardly in the trailer with the load;

FIG. 6 is a view like FIGS. 4 and 5 showing more of the material moved out from the trailer and showing the sheet member moved further rearwardly in the trailer;

FIG. 7 is a view like FIGS. 4-6 showing the load fully discharged on the ground rearwardly of the trailer and showing the sheet member in a position where most of it is outside the trailer;

FIG. 8 is a pictorial view of a guide eye, a winding reel and a strap that extends from the winding reel through the guide eye and onto a connection with the front end of the sheet member, such view showing a holding member connected to the strap;

FIG. 9 is a pictorial view of the guide eye, such view looking towards a strap passageway in the guide eye that is formed between a latch spring and a bearing;

FIG. 10 is a fragmentary side view showing the strap extending upwardly from the winding reel to and through the guide eye and from the guide eye rearwardly in the trailer;

FIG. 11 is a pictorial view taken from below the strap, and showing fasteners that extend through the strap and connect the strap to the holding member;

FIG. 12 is a pictorial view taken at the front end of the strap, showing fasteners used for fastening the front end of the strap to the winding reel;

FIG. 13 is an elevational view looking into the rear end of the guide eye for the strap, such view showing the strap in section, positioned between the latch spring and a bearing;

FIG. 14 is a sectional view taken substantially along line 14-14 of FIG. 13, such view showing the holding member contacting the latch spring when the latch spring is in a relaxed condition;

FIG. 15 is a view like FIG. 14, but showing the holding member in the process of moving passed the latch spring, such view showing the latch spring being depressed by the holding member as it moves through the strap passageway;

FIG. 16 is a view like FIGS. 14 and 15, but showing the holding member moved passed the latch member, and showing the latch member back in a relaxed position; and

FIG. 17 is an exploded pictorial view of the guide eye shown by FIGS. 13-16.

### DETAILED DESCRIPTION OF THE ILLUSTRATED EMBODIMENT

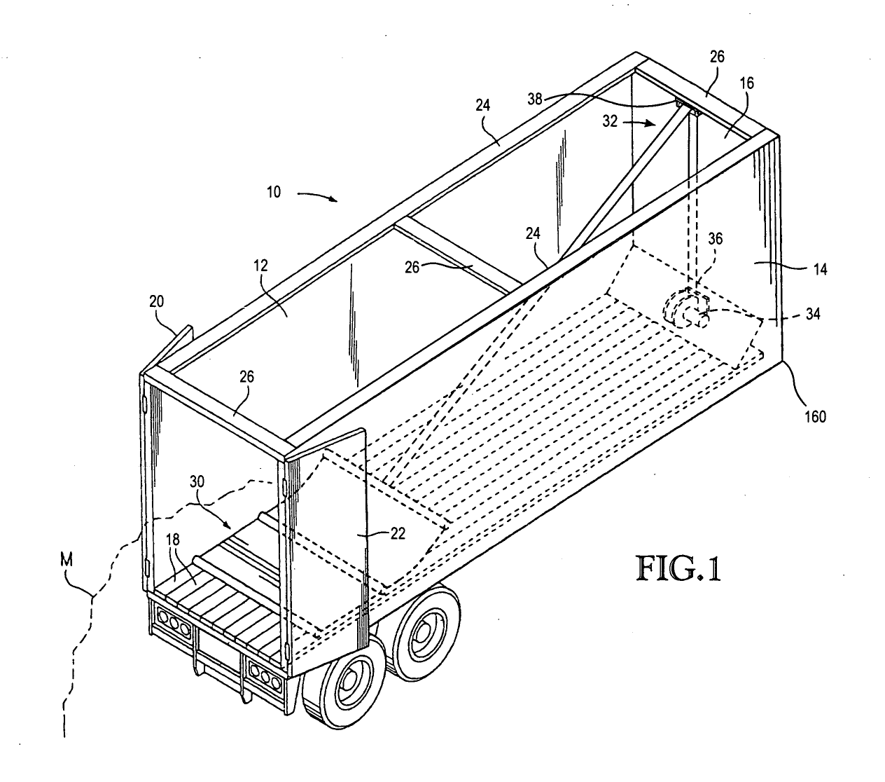

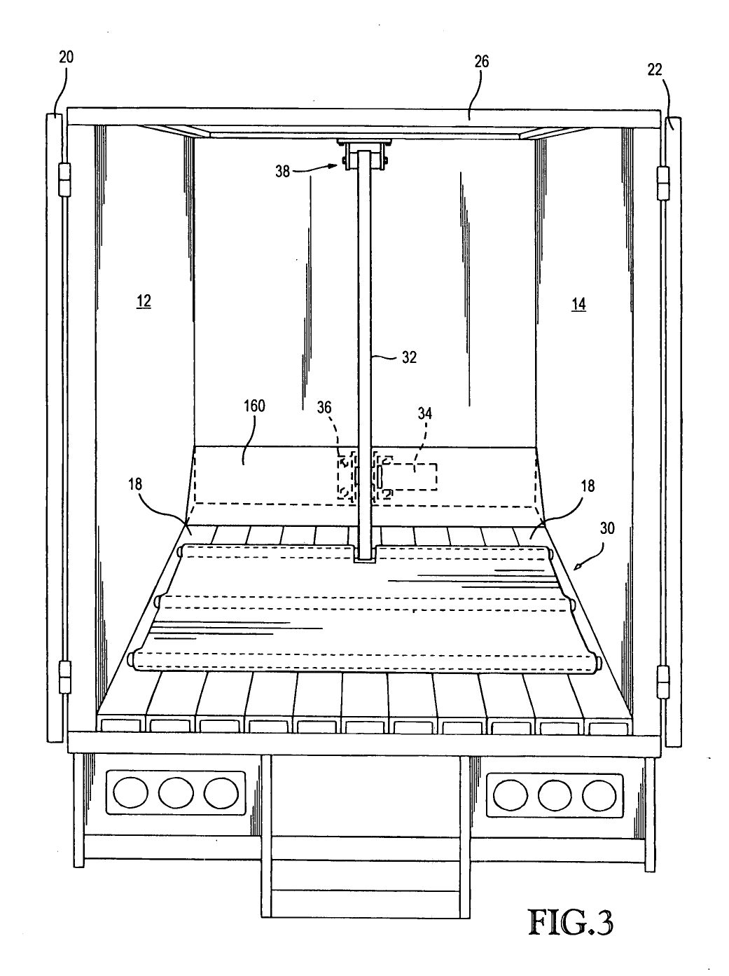

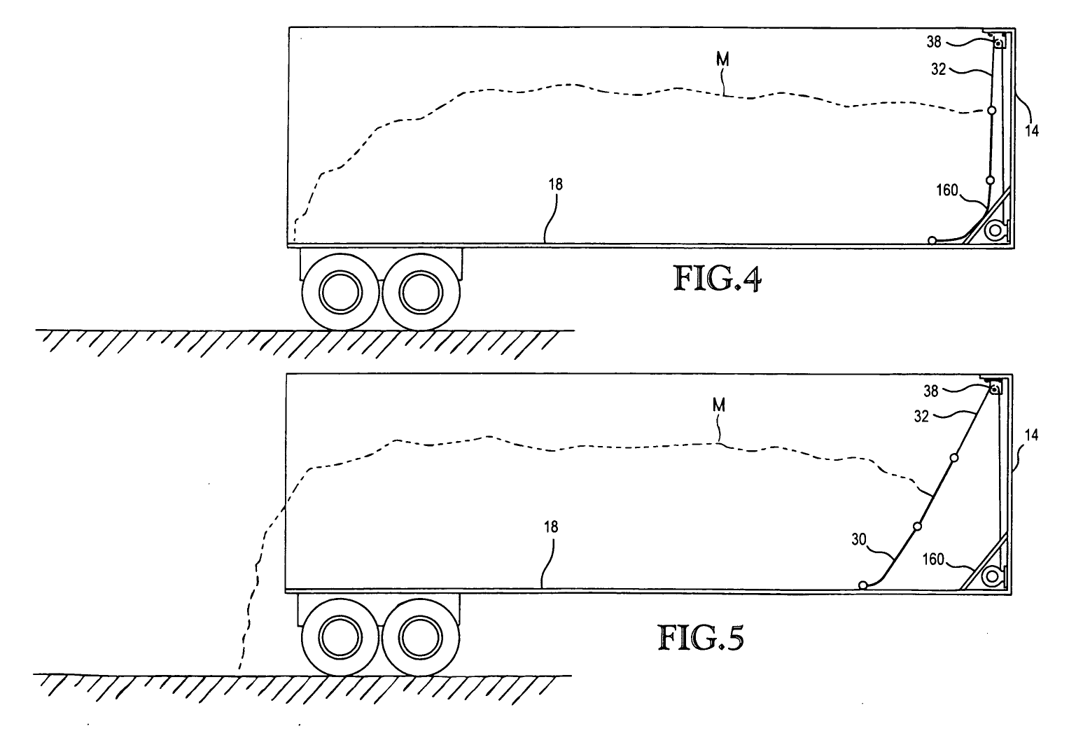

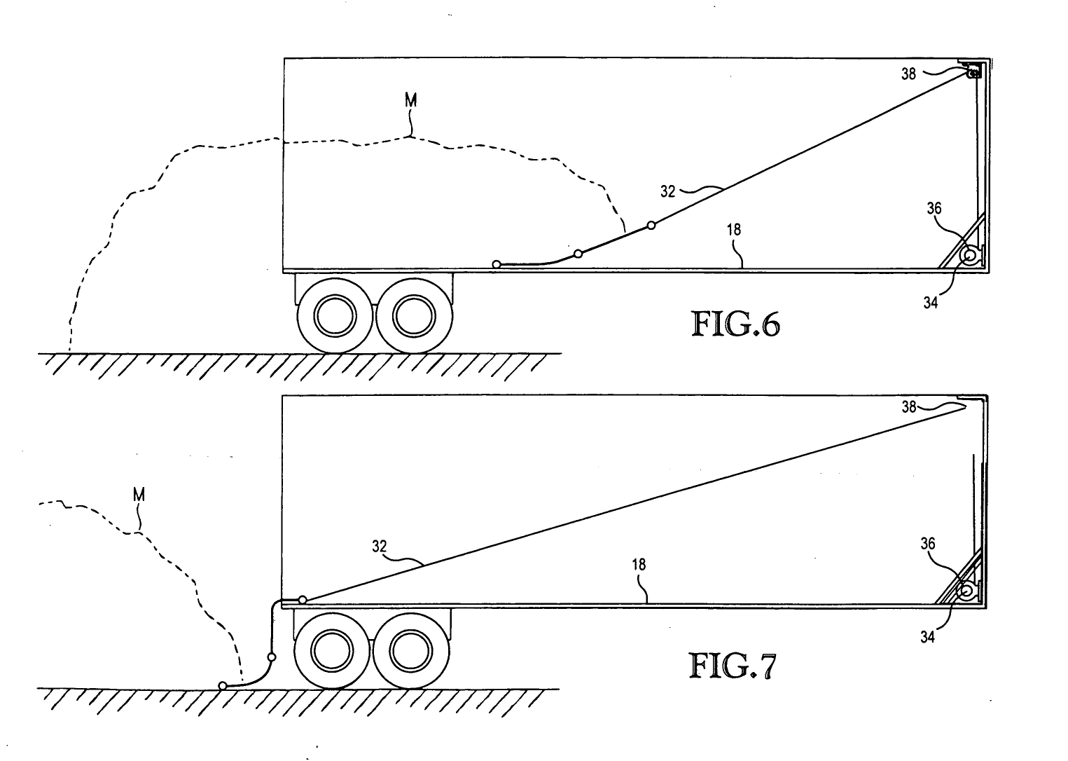

FIGS. 1-7 show a container in the form of a trailer box 10. This container comprises sidewalls 12, 14, a front end wall 16, and a floor in the form of a reciprocating slat conveyor that is composed of a plurality of side-by-side elongated slats 18. The container also includes a rear discharge opening and doors 20, 22 for closing the discharge opening. The top of the container 10 is open and may be reinforced by longitudinal and transverse frame members 24, 26.

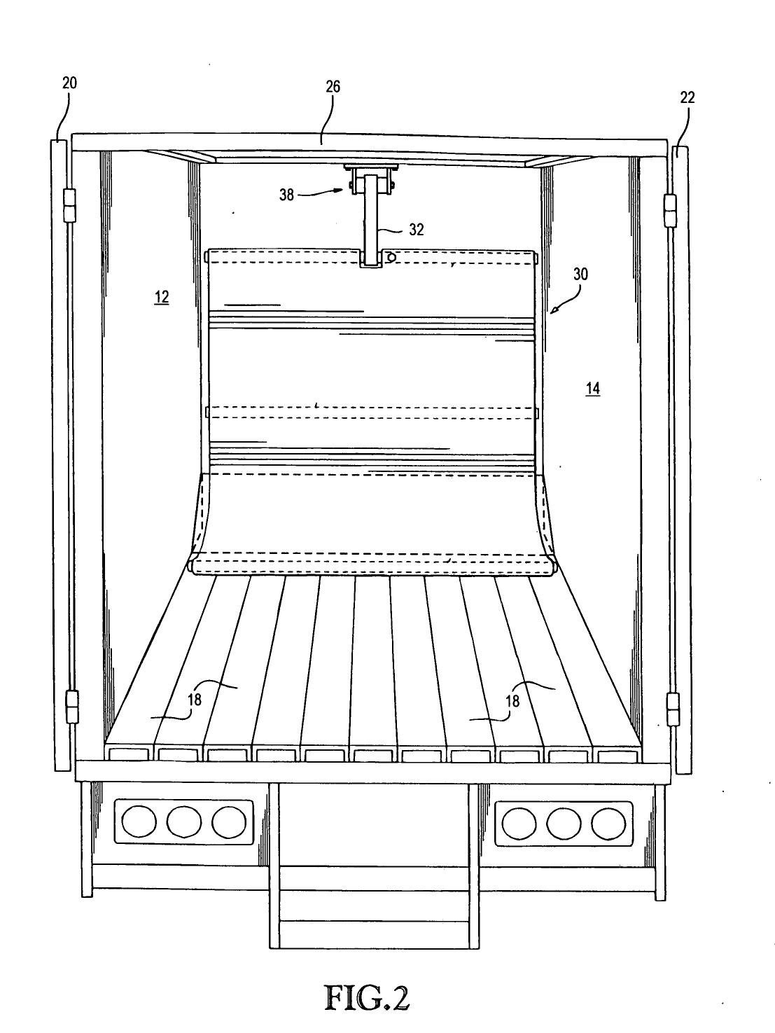

A typical reciprocating slat conveyor is disclosed in U.S. Pat. No. 4,793,469, granted Dec. 27, 1988, to Raymond Keith Foster, and entitled Reduced Size Drive/Frame Assembly For A Reciprocating Floor Conveyor. As disclosed in this patent, the conveyor slats are divided into three sets. The slats are arranged in a plurality of groups, with each group including adjacent slats, one from each set. Referring to FIGS. 2-6 of U.S. Pat. No. 4,793,769, advancement of a load “L” is accomplished by the simultaneous movement of all three sets of slats. The slats are then retracted, one set at a time.

As explained in U.S. Pat. No. 6,974,296, it is desirable to provide a reciprocating slat conveyor that is used for unloading a particulate load with a cleanout sheet that is initially positioned at the front end of the load and is moved with the load rearwardly out of the container. The cleanout system of the present invention includes a sheet member like the sheet member disclosed in U.S. Pat. No. 6,974,296. A tether in the form of a strap that extends between the front end of the sheet member and a winding reel. This sheet member is herein designated 30 and the strap is designated 32. A feature of the present invention is to directly couple a rotary hydraulic drive motor 34 to a winding reel 36. When the motor 34 is turned off, the winding reel 36 is free to rotate and would be caused to rotate by the weight of the sheet member 30 acting on the tether 32 unless such movement is prevented. The hydraulic motor 34 is operated by oil that is pumped to and through it by a suitable pump. When the pump is turned off, the oil is free to return to tank. There is nothing then that will prevent the motor from rotating under a force applied on it, such as by movement of the strap 32.

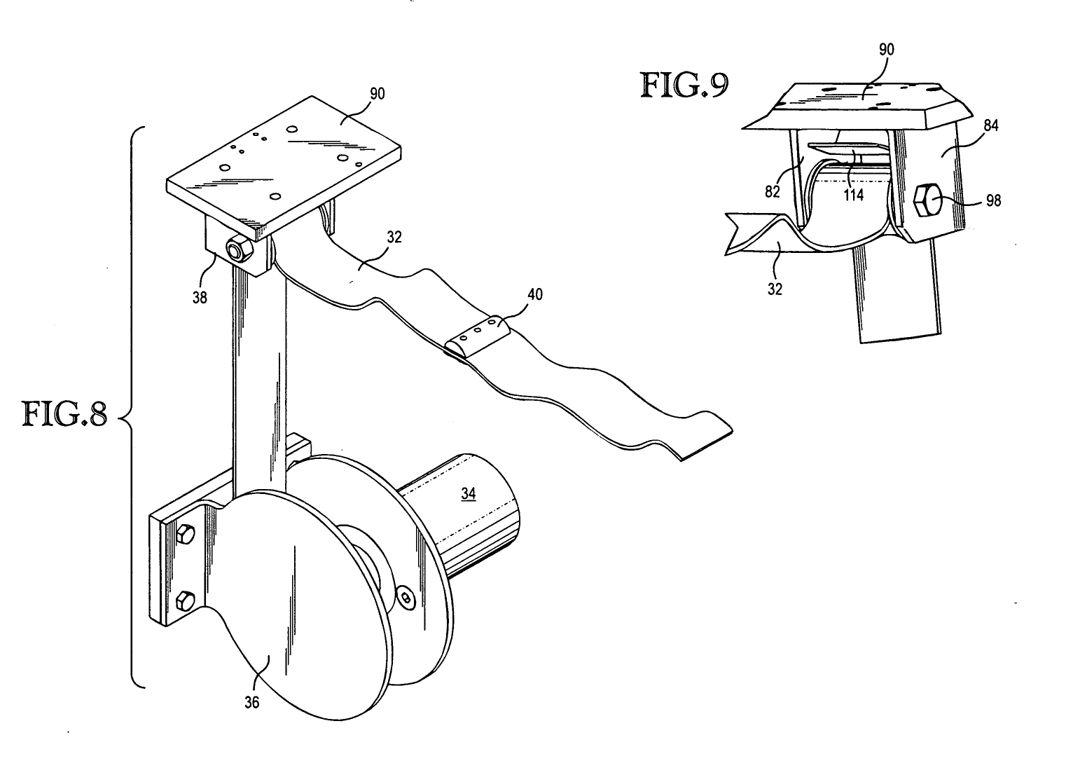

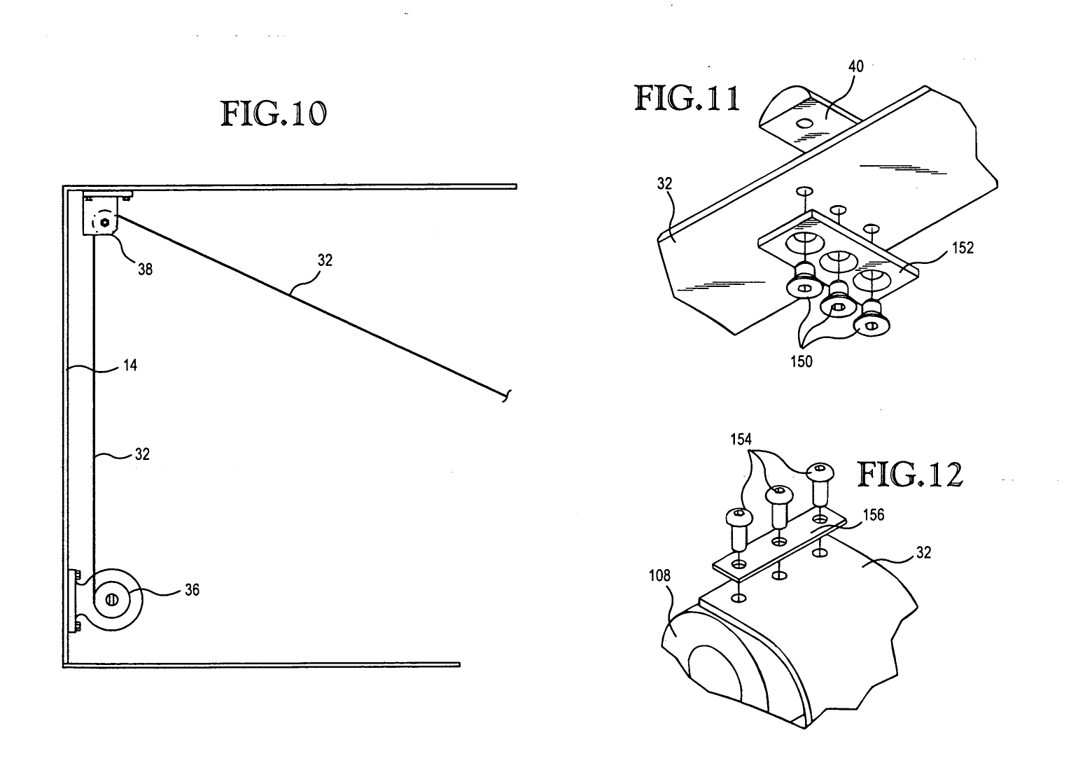

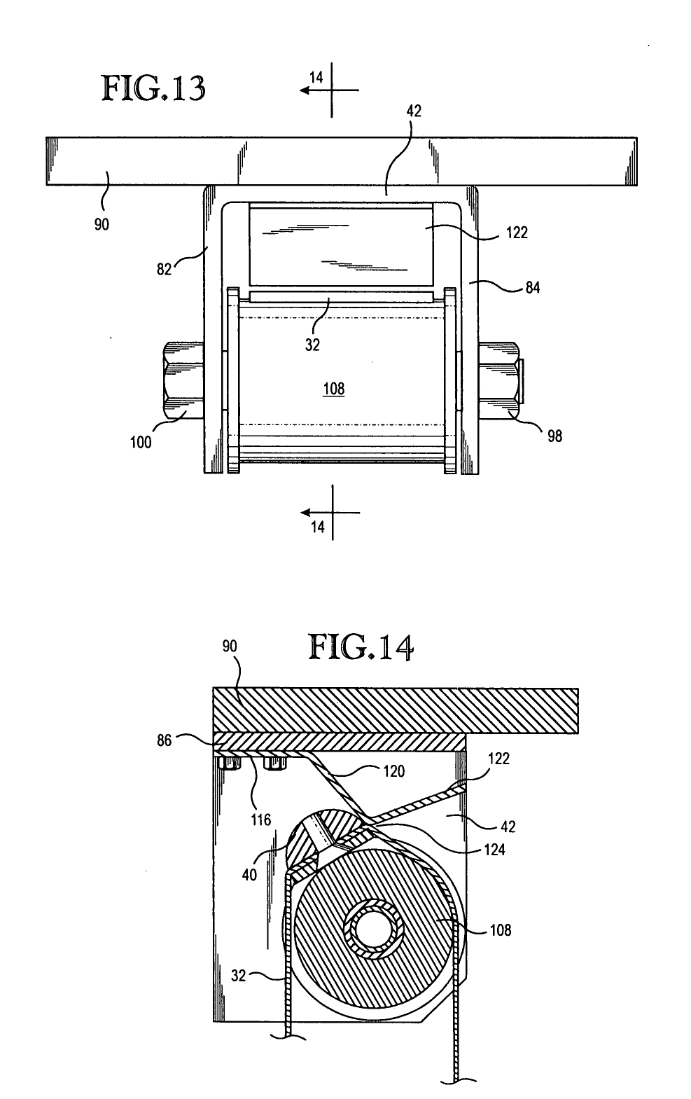

According to the present invention, the strap 32 is wound onto the winding reel 36. The strap 32 then extends from the winding reel 36 to and through a guide eye 38 and from the guide eye 38 to a connection to the front end of the sheet member 30. As clearly shown by FIGS. 8, 11, 12 and 14-16, a block 40 is connected to the strap 32 and the guide eye 38 is constructed to contact the block 40 and prevent it from moving through the guide eye 38 except under two conditions of operation. When the sheet member 30 is in an elevated position against the front end wall 16, as shown in FIG. 2, the strap is held against movement by contact of a latch spring 42 in the guide eye 38 and the block 40. This holding of the strap 32 prevents the sheet member 30 from pulling on the strap 32 and as a result the strap 32 holds the sheet member 30 in the position shown by FIG. 2.

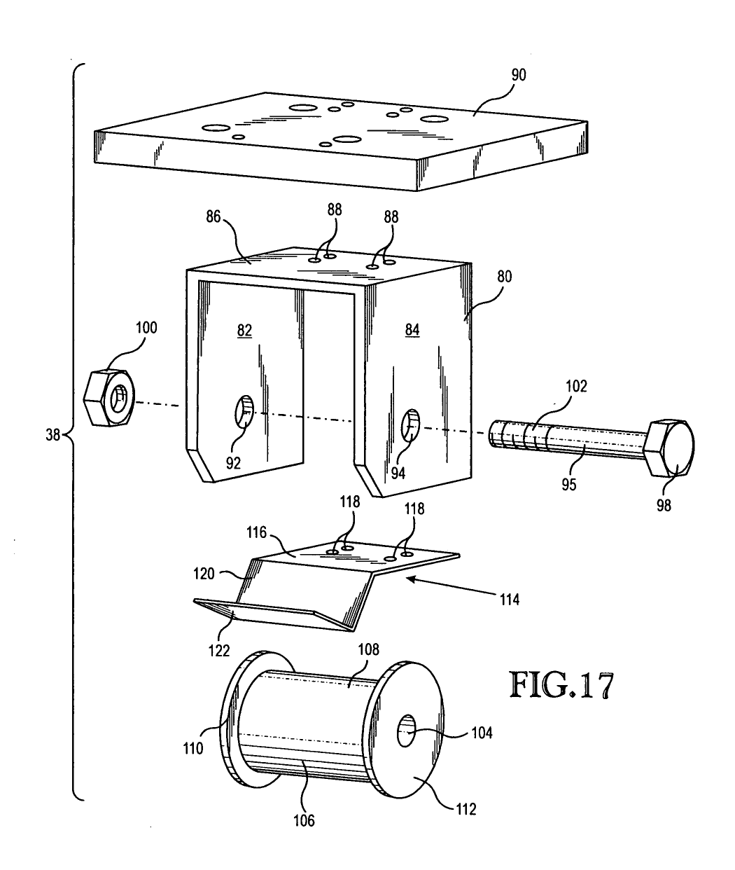

As best shown by FIG. 17, the guide eye 38 may comprise a substantially U-shaped yoke and comprises sidewalls 82, 84 and top wall 86 that extends between the upper ends of the sidewalls 82, 84. Mounting screws (not shown) may extend through screw openings 88 and top wall 86 and screw into a mounting plate 90. Mounting plate 90 may be fastened to the front top rail 26, such as by screw fasteners or bolts.

A pair of aligned bolt-receiving openings 92, 94 are formed in the sidewalls 82, 84. An axle bolt 96 extends through the openings 92, 94. A head 98 at one end of the bolt 96 contacts sidewall 84. A nut 100 screws onto threads 102 at the opposite end of the bolt 96 and contacts sidewall 82. Axle bolt 96 extends through a center line passageway 104 in a reel 106 that includes a cylindrical center portion 108 and disc-shaped end members 110, 112. The reel 106 is positioned between the sides 82, 84 of the yoke 80 and then the axle bolt 96 is moved first through opening 94, then through the center passageway 104 and then through opening 92. Then, nut 100 is screwed onto threads 102. A leaf spring 114 having a mounting portion 116 is secured to the top wall 86 of yoke 80, preferably by the same fasteners that extend through the openings 88 in the top 86. These fasteners are first inserted through openings 118 in mounting portion 116 and then through the openings 88 in the top 86. Leaf spring 114 includes a latch spring section that is preferably bent to have a dihedral shape composed of panels 120, 122. Referring to FIGS. 14-16, when the mounting panel 116 is connected to the top wall 86 of the yoke 80 and to the mounting plate 90, the dihedral panels 120, 122 form sloping stop surfaces in each direction through the guide eye. Dihedral panels 120, 122 together form an apex 124 which confronts the roller 108. A throat is formed between the apex 124 and the roller 108 that is substantially narrower than the thickness of the block 40 that is carried by the strap 32. As shown by FIG. 14, the strap 32 can easily move through the guide eye 38 until the block contacts the sloping surface 120 of the latch spring 42. The contact of the block 40 with the latch spring 42 will momentarily stop any further movement of the strap 32 through the guide eye 38. However, since the latch spring 42 is a spring, if sufficient force is imposed on the sloping surface 120 by the block 40, the block 40 will depress the latch spring 42 to enlarge the throat and allow the block 40 to pass through the throat.

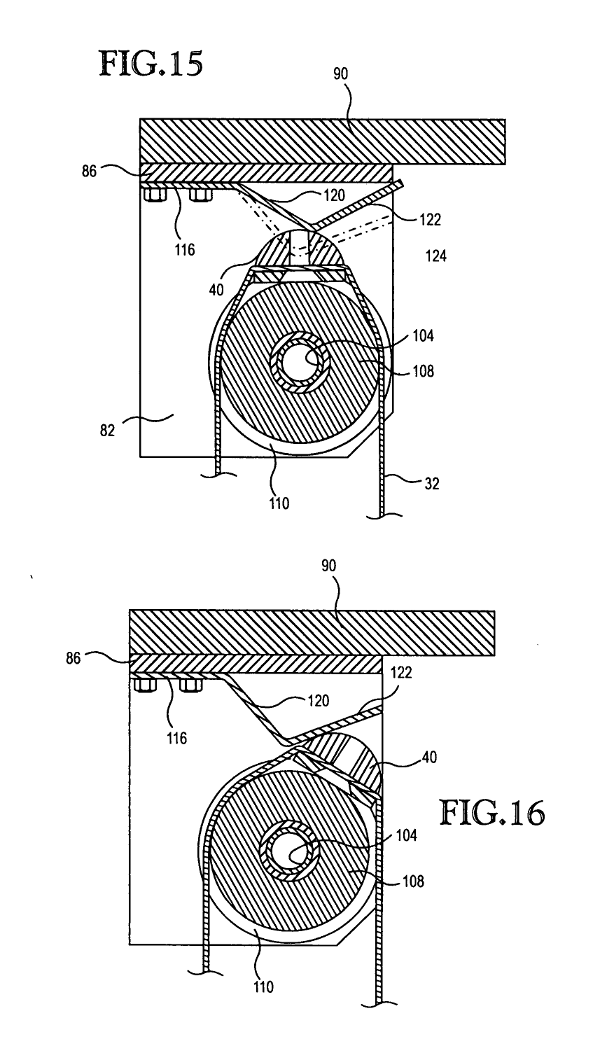

FIG. 15 shows the block of 40 in the process of depressing the latch spring 42 and moving through the throat. FIG. 16 shows the block 40 on the opposite side of a latch spring 42 from the position shown by FIG. 14. When block 40 is in the position shown by FIG. 16, the latch spring 42 blocks it from moving back through the throat of the guide eye 38. That is, it holds it and the strap from moving in the reverse direction until a sufficient force is generated on the sloping surface 122 to cause the latch spring to again deflect and enlarge the throat of the guide eye 38 a sufficient amount to allow the block 40 to move back through the throat.

The motor 34 acting on the winding reel 36 both winds the strap 32 on the winding reel 36 and moves the block 40 against the surface 122, to deflect the latch spring 42 and allow passage of the block 40 through the throat of the guide eye 38. When the sheet member is in the position shown by FIG. 2, and particulate material M is on a lower portion of the sheet member 30, there is insufficient force pulling on the strap 32 to cause the block to move back through the throat of the guide eye 38. The latch spring 42 holds the block 40, and hence the strap 32, against movement from the position shown in FIG. 2. However, when the reciprocating slat conveyor is operated to move the material M out from the container 10, the weight of the material M acting on the sheet member 30 and the pull imposed by the conveyor slats 18, create a force on the strap large enough to move the block 40 against panel 120 with sufficient force to depress the latch spring 42 and open the throat of the guide eye 38 and allow the block 40 to move rearwardly through the throat of the guide eye 38. As can easily be seen from an examination of FIGS. 14-16, after the block 40 moves through the throat of the guide eye 38, in either direction, the force imposed on latching spring 42 by the block 40 will be released and the latching spring 42 will return back to a relaxed position, i.e. the position shown by FIGS. 14 and 16.

The roller 108 is one form of bearing that cooperates with the apex 124 of the latching spring 42 to form the throat of the guide eye 38. The roller 108 is preferred. However, the bearing can take a different form. For example, it can be a fixed member presenting a smooth surface to the strap 32 over which the strap 32 can easily move.

Referring to FIG. 11, the block 40 may be connected to the strap 32 by means of screws 150. A plate 152 is placed against the strap 32 on the opposite side of the strap from the holding member 40. Screws 150 extend through openings in the plate 152 and openings in the strap 32 and thread into threaded openings in the holding member 40. Referring to FIG. 12, the end portion of the strap 32 that is connected to the roller 108 may be connected by a similar group of screws 154. The screws 154 may extend through openings in a plate 156 and then through openings in strap 32 and then screw into threaded openings in the roller 104.

FIGS. 1-7 show positioning the winding reel 36 and its drive motor 34 forwardly of a sloping plate 160 that is at the front end of the trailer 10. This plate 160 extends upwardly and forwardly from the reciprocating slat conveyor to the front end wall 14. A suitable passageway for the strap 32 must be provided in the plate 160. The exact placement of the winding reel 36 is not a critical feature of the invention. It is also possible to mount the winding reel 36 and its motor 34 further upwardly on the front end wall 14. Also, the winding reel 36 and its motor 34 can be mounted outside of the trailer 10, either on the front end wall 16 or forwardly of the front wall 16. In that case, the strap 32 passes forwardly through the guide eye 38 and then onto the winding reel 36

The illustrated embodiment is only an example of the present invention and, therefore, is non-limitive. It is to be understood that many changes in the particular structure, materials and features of invention may be made without departing from the spirit and scope of the invention. Therefore, it is my intention that my patent rights not be limited by the particular embodiment that is illustrated and described herein.

What is claimed is:

1. For use with a reciprocating slat conveyor in a container that has spaced apart sidewalls, a front end wall and a rear end discharge opening, a cleanout system, comprising:
a sheet member having a front end, a rear end and side edges that are adjacent the sidewalls of a container;
a guide eye connected to an upper forward portion of the container;
a winding reel spaced from said guide eye;
a strap extending downwardly through the guide eye to a connection with the front end of the sheet member, and extending upwardly from the guide eye to the winding reel, said guide eye being elevated in the container to such an extent that the strap can be wound on the winding reel to pull the front end of the sheet member into an elevated position below the guide eye and adjacent the front end wall of the container;
said guide eye including a strap passageway defined on one side by a bearing and on the other side by a latch spring, whereby the strap is positioned to move lengthwise in the strap passageway between the bearing and the latch spring;
a block on the strap, that when the latch spring is relaxed is thicker than the strap passageway is deep;
wherein in response to the strap being wound on the winding reel, the block is moved through the strap passageway against the latch spring, depressing the latch spring to allow the holding member to move into a position passed the latch spring, wherein said latch spring moves back into a relaxed position when the holding member is said opposite side of the guide eye; and
wherein when the block is on the opposite side the latch spring will engage the block and block it from moving back through the strap passageway.

2. The cleanout system of claim 1, wherein the sheet member is reinforced by a plurality of laterally extending stiff ribs, including a rib at the front end of the sheet member, and wherein the strap is attached to such rib at the forward end of the sheet member.

3. The cleanout system of claim 1, wherein the bearing is a roller.

4. The cleanout system of claim 1, wherein the block is secured to the strap on the side of the strap opposite to side that confronts the bearing.

5. The cleanout system of claim 1, wherein the latch spring has a mounting portion that is connected to a support and a leaf spring portion that it cantilevered from said mounting end portion, said leaf spring portion having a dihedral shape formed by sloping panels which meet at an apex, wherein the strap passageway is defined between said apex and said bearing, and wherein the holding member is positioned on the strap to make contact with the sloping panel on its side of the guide eye.

6. The cleanout system of claim 5, wherein the bearing is a roller.
